(19) United States
(12) Patent Application Publication
(10) Pub. No.: US 2001/0034839 A1
(43) Pub. Date: Oct. 25, 2001

(54) Method and apparatus for secure transmission of data and applications

(76) Inventors: Guenter Karjoth, Waedenswil (CH); Luke J. O'Connor, Adliswil (CH)

Correspondence Address: Ronald L. Drumheller, Esq, 94 Teakettle Spout Road, Mahopac, NY, 10541, US

(21) Appl. No.: 09/748,446

(22) Filed: Dec. 26, 2000

(30) Foreign Application Priority Data
Dec. 24, 1999 (EP) 99811208.0

(51) Int. Cl. H04L 9/32; H04L 9/00

(52) U.S. Cl. 713/190; 713/176; 713/187

(57) ABSTRACT

Authenticated transmissions are usually time-consuming and often provide delayed error recognition and correction. This is a problem particularly with hand-held computing devices like personal digital assistants (PDAs), smart phones or smartcards, since these usually possess limited memory, processing power and communications bandwidth. Because of these limitations and generally low transfer rates between the device and a provider or central computer base, such transmissions are time-consuming and delay applications. The late detection of unavoidable transmission errors is especially cumbersome. By applying an optimally taylored authentication scheme to a block-wise transmission and in particular by applying a tree structure for the authentication process during such transfers, the present invention minimes the unavoidable delays and thus provides a solution for these problems.

### DESCRIPTION

1. Field of the Invention

Hand-held computing devices like personal digital assistants (PDA), smart phones or smartcards are typically limited in terms of memory, processing power and communications bandwidth. Because of these limitations, aggravated by the generally low data transmission rates between the device and a central application provider, e.g. a computer base, such transmissions are rather cumbersome and need relatively long times. This applies to any data or program exchange with the device, be it the downloading or incrementing of applications or the uploading of data. Delays are unavoidable because of both the limited memory in the device and the required security.

2. Introduction and Prior Art

In this description, the present invention will be discussed with specific reference to smartcards as typical examples of hand-held computing devices, with the understanding that the same solution is directly applicable to other portable devices with similar properties. Generally, a smartcard is a card similar in physical characteristics to common magnetic stripe cards, such as banking or credit cards. Additionally, a smartcard typically contains one or several micro-processors and also possesses larger amounts of memory than found in magnetic stripe cards. Consequently a smartcard is a sufficiently powerful device to perform complex applications such as banking or payment, and further, such applications may be securely executed using authentication, encryption and digital signatures. Typically, today's smartcards have 2 kB of RAM and 16 kB of ROM, and the data transmission rate between the central computer base and the smartcard is 9600 Baud (B/second).

A general computing device, such as a PC or a workstation, stores applications in some permanent storage media, such as a hard disk, and then reads an application into main memory (RAM) for execution as required. Subject to available memory, new applications can be freely added while old applications can be easily removed or updated. However for a smartcard, given its limited memory capacity, applications are typically loaded into its ROM at the time of fabrication. This approach is convenient for the large scale production of smart cards supporting one or a few fixed applications. But this approach is less suitable if the set of applications to be supported is expected to change, or if old applications need to be updated, or if the number of cards supporting a given application are not to be produced in large quantities.

A more flexible approach is to design the smartcard so that applications can be downloaded to the card as required. For example, in the ESPRIT project CASCADE of the European Union, a smartcard was designed where the pre-installed software consists of a small boot kernel, libraries for basic I/O and cryptography, and a secure downloading mechanism, where other applications and systems code are downloaded securely to a FLASH memory (approximately 16 KB) to the card. In the Internet publication http.//dice.ucl.ac.be/crypto/cascade/cascade.html, this approach is described in detail. Since an application may be quite large with respect to the amount of RAM or bandwidth available to the smartcard, it is anticipated that an application will be partitioned into code blocks B1, B2, . . . , Bn and each code block will be downloaded in a separate communication to the smartcard. Also, if an application is to be updated, then only those blocks that have been modified need be re-installed on the smartcard. We note that the code blocks may represent either application code and/or application data.

Using this scheme of code block partitioning, there are two parameters of special interest in evaluating a given solution with respect to downloading and updating code blocks: delay requirements and memory requirements.

Delay:

The download or updating of code blocks should be “on-the-fly” in the sense that blocks which are incorrect due to some error should be detected quickly to avoid wasting bandwidth and memory. Assuming that at each time unit a new block arrives at the smartcard during download or update, if now a block Bi arrives at time t, but cannot be verified (e.g. by a hash check) until the arrival of block B(i+d) at time t+d, then we say that the verification of Bi is delayed for d blocks. For a given scheme, we are interested in the maximum delay for block verification. We will say that verification is “on-the-fly” if the maximum delay is constant or fixed, which will be denoted as O(1).

Memory Requirements:

As code blocks arrive, they must be stored, and there is an amount of additional memory necessary for intermediate calculations to verify the received blocks.

For code download, the time to process n blocks is proportional to n, denoted as O(n); the memory and block verification time may also be O(n). A protocol demonstrates a gain in efficiency if either the memory or verification delay is reduced, possibly to O(log n), or even to O(1). If n code blocks B1, B2, . . . , Bn are to be downloaded, we not only require authentication on each block, but also on the blocks as a whole, so as to authenticate the application represented by all the code blocks collectively.

One approach to establishing the authenticity of the application is to create dependencies between the blocks via cryptographic hashing, and cryptographically signing a hash value that depends on all blocks.

For a different problem, R. C. Merkle described an interesting approach in “A Certified Digital Signature” in Advances in Cryptology, CRYPTO 89, LNCS vol. 218, G. Brassard ed., Springer-Verlag, pages 218-238, 1989, later patented in Merkle U.S. Pat. No. 4,309,569. The authentication tree disclosed by Merkle is intended for authenticating a large number of public values with a single signature, such as a collection of public key certificates in a database, but this so-to-speak static approach does not address the specific problems and dynamics of secure downloading data or code, particularly onto a device with limited memory capacity and/or limited processing power, e.g. a smartcard.

On the other hand, the CASCADE approach mentioned above does not use an authentication tree. Instead, it employs a “linear” hash chain, such that Bi depends on B(i+1), B(i+1) then depends on B(i+2) and so on, which implies that a large part of this chain must be recomputed if one block is updated. Thus, though the CASCADE approach has an advantage over the prior art methods since it is not necessary to recompute or retransmit all code blocks, it is still a rather lengthy and cumbersome process.

A specific problem related to the secure download/update of applications on a portable device is that of signing digital data streams, sometimes referred to as digital flows. Several applications, such as video on-demand distribution or stock market feeds, require large amounts of data to be delivered from a set of data sources to a set of data receivers. Usually the data will be encrypted, but it is also required that the receivers be able to verify the source from which the data originated, such as a video server or an agent of the stock market. Since the data stream is typically divided into packets, each packet could be signed individually for proof-of-origin, but this would place a high computational burden on both the sender and all receivers. For real-time services, such as video on-demand, most receivers will not have enough processing power to perform a signature verification for every packet received without adversely effecting the quality of the service.

There are various approaches to solving the stream signature problem, but most are based on the idea of hashing together n data packets and then producing one signature for all these packets. Thus the “cost” of one signature generation/verification is spread over n data packets, relieving the work at both the sender and the receivers. This general approach is similar to the one outlined for the present application download/update problem, but there are several important differences that make the solutions to the two problems different. First, for digital streams there is really no notion of updating data, especially for real-time services, as data that is sent is either received or lost due to some error, and there is no time to request that the data be sent again. Second, since data streams may be transmitted over large networks with widely varying qualities of service, one must cope with the loss of packets. This implies that a signature computed over n packets may be unverifiable if one of the packets is lost in transmission. Generally in the application download/update scenario, packet or code block loss is not a serious problem, and the protocol need not be specifically tailored to accomodate errors in transmission. A related issue is that of packets being reordered during transmission, which is a common characteristic of general packet-switched networks, but not for the here anticipated scenario for application download/update.

An interesting solution for signing digital data streams present Wong and Lam in “Digital signatures for flows and multicasts”, published in the IEEE/ACM Transactions on Networking, 7(4), pp. 502-513, August 1999. In the Wong-Lam solution, the stream is broken into n=2^{d} packets P1, P2, . . . , Pi, . . . , Pn that are collected into a transmission group TG. The packets of TG are then arranged to be the leaves of a Merkle authentication tree T, and the hash of the tree is computed and signed by the sender to produce Sign(TG). When TG is transmitted, each packet Pi is sent with the sequence of hash values that were used to form the path in the hash tree from the leaf representing Pi to the root of the authentication tree T. The signature Sign(TG) on the authentication tree T is also sent with each packet and packet hash path. This permits each packet Pi to be verified as it is received, even though other packets in the TG of Pi may have been lost or reordered. To verify a given packet Pi, the receiver is typically required to recompute the path in the authentication tree from the leaf representing Pi to the root of T, and then verify Sign(TG) based on the computed root hash. The full hash path from the leaf to the root must be computed for the first packet received, but the verification of subsequent packets can be optimized by re-using hash values that were previously computed, verified and then cached The next received packet P(i+1) is verified by hashing it until a node in the cache is reached that was previously authenticated. The cache structure suggested by Wong-Lam mimics the structure of the original authentication tree at the sender used to compute the signature on TG. The receiver then requires a storage of the size O(n) since this is the size of the authentication tree.

Though the described Wong-Lam approach allows verification on-the-fly and thus inherently provides a solution for data packet loss, it requires transmission of a substantial amount of verfication data with each packet in addition to the “useful” data. It also requires a substantial amount of computing at the receiving end. Since this can result in a rather poor overall transmission efficiency, the Wong-Lam solution may be useful and/or applicable only in certain environments.

The present invention improves the prior art approaches, in particular the Wong-Lam approach, by providing a solution that has two advantages over this known method. First, the present invention needs a significantly lower amount of verification data to be transmitted with each data packet than Wong-Lam. Second, the present invention differs in that it lowers the amount of storage required at the receiving end without increasing the time for verification at the receiver. Thus, the general object of the present invention can be said to allow safe transmission between an application or service provider and a portable device having a limited storage or memory capacity and/or restricted processing power, such as smartcards and the like. A particular object of the present invention is to provide a method and an apparatus with a faster and/or simpler, but still secure, transmission process than the prior art, in particular by reducing the number or lengths of transmissions to be executed in an environment where data and/or applications have to be transferred securely, and/or limiting the necessary computing and thus providing a significant improvement at the receiving end, which is typically a smartcard or similar device with the limitations mentioned above.

A special object is to provide an efficient method in terms of storage and verification time to dowload code blocks from an application provider to a portable device such as a smartcard.

A more particular object of the present invention is to increase the efficiency of updating code blocks for existing applications of smartcards and similar devices with limited memory and/or computing power.

### THE INVENTION

The present invention provides this solution by selecting a novel approach which will be called “Dynamic Tree Authentication” (DTA) in the following. It differs from the CASCADE and the Merkle approaches as well as from the Wong-Lam approach described above.

Whereas the CASCADE solution creates a linear hash chain, the solution according to the present invention uses an authentication tree to create a “nonlinear” hash chain for block update, preferably with a logarithmic length hash path. The present invention also introduces a new method for evaluating the order of the nodes in the authentication tree. Particularly this latter approach reduces verification delay from linear time, i.e O(n) as identified above, to constant time, i.e. O(1), which is the maximum achievable.

The Merkle approach, as mentioned above, uses the principle of an authentication tree, but only for a principally static method of providing digital signatures or authenticating items. It does not address the peculiarities and dynamics of a transmission to a receiver with limited memory and/or computing capacity. The invention instead focuses on this latter problem and creates a novel transmission pattern or scheme, based on a modified authentication tree process.

The present invention can be seen as an optimization of some ideas presented by Wong-Lam for signing digital streams, tailored to the specific problem of application download/update. There are applications wherein a digital stream is sent from a sender to a group of receivers, for example a set of subscribers for a video service, or the participants in a teleconference. The digital stream consists of a large amount of data, potentially generated in real time, to be distributed over a communication channel that may provide an unreliable delivery service. Further, the communication may be one-way in the sense that the receivers have no channel back to the sender to conform receipt of the stream or identify stream errors. Or, if a back channel does exist, the bandwidth on this channel is very low. Together these characteristics imply that any signature scheme must be sufficiently robust to handle packet loss and reordering and to support signature generation and verification functions that are efficient enough to allow fast delivery of the stream.

The application download problem can be viewed as a digital stream between a single sender (the application provider, AP) and a single receiver (the smartcard, SC). In this case the receiver is a very constrained device, and the signature verification algorithm should not require large amounts of computation or storage. The channel between the AP and the SC is generally reliable but slow, so that the signed stream should be formatted as efficiently as possible without regard for packet loss or reordering. Therefore it is possible to propose a method for signing application code blocks that improves a direct application of the Wong-Lam solution for digital streams.

In some more detail, the invention is based on the use of an authentication tree to amortize the computation of the digital signature over a collection of code blocks, similar to the Wong-Lam approach where the authentication tree is used to amortize the computation of the digital signature over the packets of a transmission group. Since packets may be lost or reordered, the Wong-Lam approach appends to each packet Pi its hash path in the authentication tree, along with the signature on the authentication tree, which permits each packet to be verified independent of what other packets from the transmission group are received. The receiver reconstructs the original authentication tree of the sender by caching the hash values of the hash paths for packets that are received. This means that for transmission group of n packets, each packet is sent with O(log n) hashes and a copy of the signature on the authentication tree, which will be several thousand bits in length. Thus an additional O(n log n) hashes and O(n) copies of the signature on the authentication tree must be transmitted along with the n packets of the transmission. Also, the receiver requires O(n) storage to verify the packets of the transmission group. So much on Wang-Lam.

The present invention provides a signature on a collection of n code blocks (which can roughly be viewed as a tramission group) based on an authentication tree where only O(n) additional hashes and one copy of the signature on the authentication tree are required to be transmitted by the sender. This alone distinguishes the invention already from Wang-Lam. Further, the receiver need only use O(log n) storage to verify the collection of n application code blocks. This provides a clear advantage of the present invention over the Wong-Lam approach for signing digital streams when applied to the application download problem. The improvement over Wong-Lam is derived from taking advantage of the reliable channel that is expected to exist between the AP and SC, thus allowing the amount of redundant signaling information that would otherwise be sent with the code blocks to be reduced.

To summarize, the present invention can be said to be a solution for verifying a code block in the transmission of data and/or applications from a provider to a receiver with limited memory and computing power, particular for downloading, updating and/or incrementing applications that has the following properties:

1. each code block is verified after an essentially constant delay,

2. the overhead in terms of additional signature information that must be transferred with the code blocks to obtain the constant delay is linear in the number of code blocks,

3. the amount of memory required by the receiver to verify each received code block is logarithmic in the number of blocks, and

4. an individual code block can be updated with a logarithmic transmission cost, and a logarithmic cost for verfication and memory at the receiver.

While other solutions satisfy some of these properties, the present invention is novel in that it satifies all properties. Thus, Dynamic Tree Authentication (DTA) offers a good tradeoff between delay and memory as each of the main parameters is either a logarithmic function of the number of blocks n to be downloaded, or is independent of n. This is a clear advantage and improvement over known methods which normally require either O(n) for the memory or verification delay in one or both of code block downloading and updating.

In other words, whereas the application of an authentication tree to the download/update/increment code block problem results in detecting if an error has occurred but not the location of which block(s) are incorrect, DTA, i.e. the Dynamic Tree Authentication according to the present invention, allows to identify in which block one or more errors are located.

### DESCRIPTION OF AN EMBODIMENT

In the following, the aspect of the application of an authentication tree structure to the download/update/increment code block problem when transmitting to smartcards and the like and the Dynamic Tree Authentication method (DTA) will be discussed in more detail, taking a protocol between a smartcard (SC) and an application provider (AP) as example. It is assumed that the SC has AP's public key and can thus check signatures on data produced by the AP.

Apart from pseudocode listings within the text, this description is sup-ported and completed by the appended drawings which illustrate in:

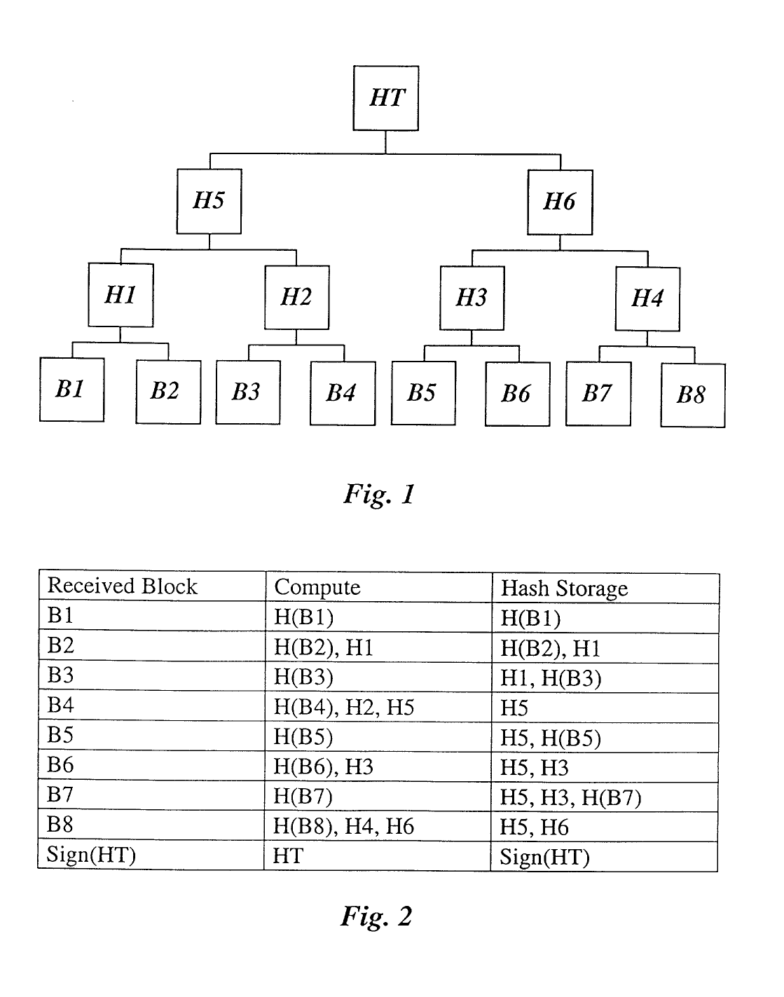

FIG. 1 an authentication tree for n=8;

FIG. 2 a table for the storage required to verify a tree authentication for n=8;

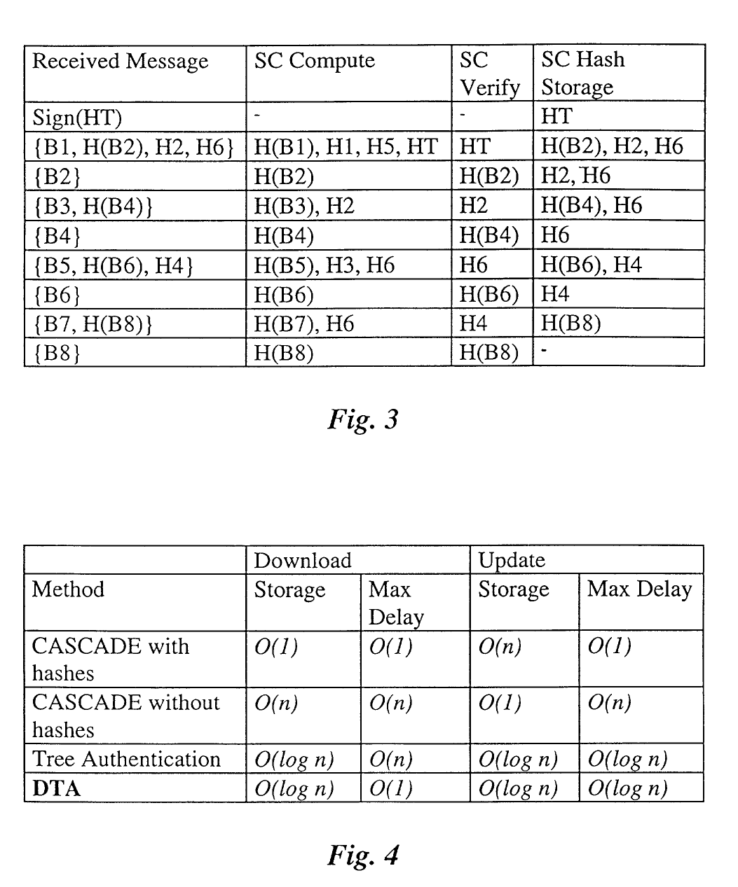

FIG. 3 a table for the storage requirements for DTA for n=8;

FIG. 4 a summary of time and storage requirements for code block download and update;

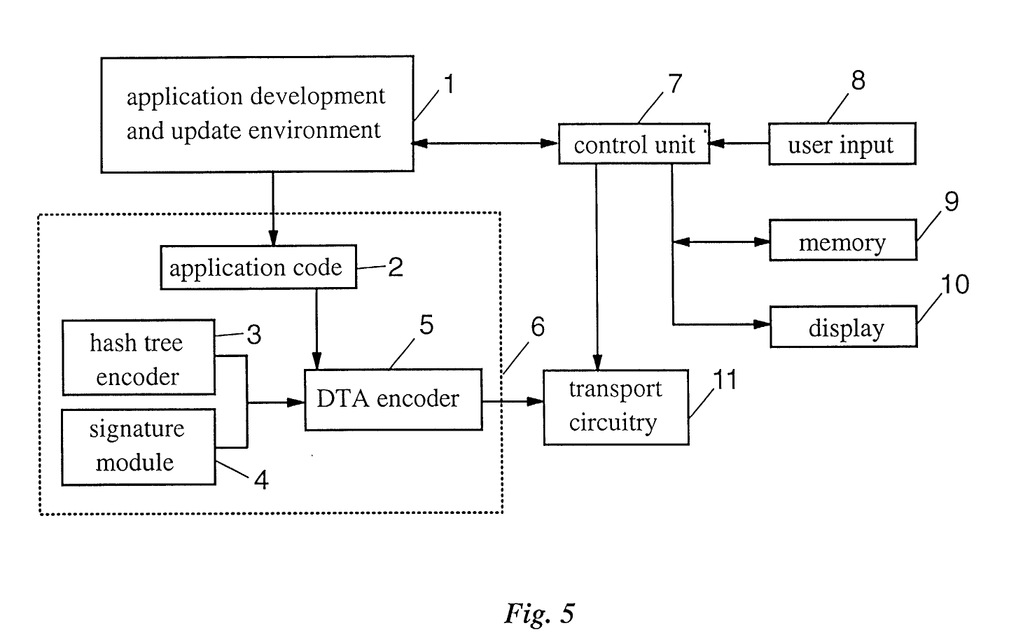

FIG. 5 a functional example for an application provider (AP);

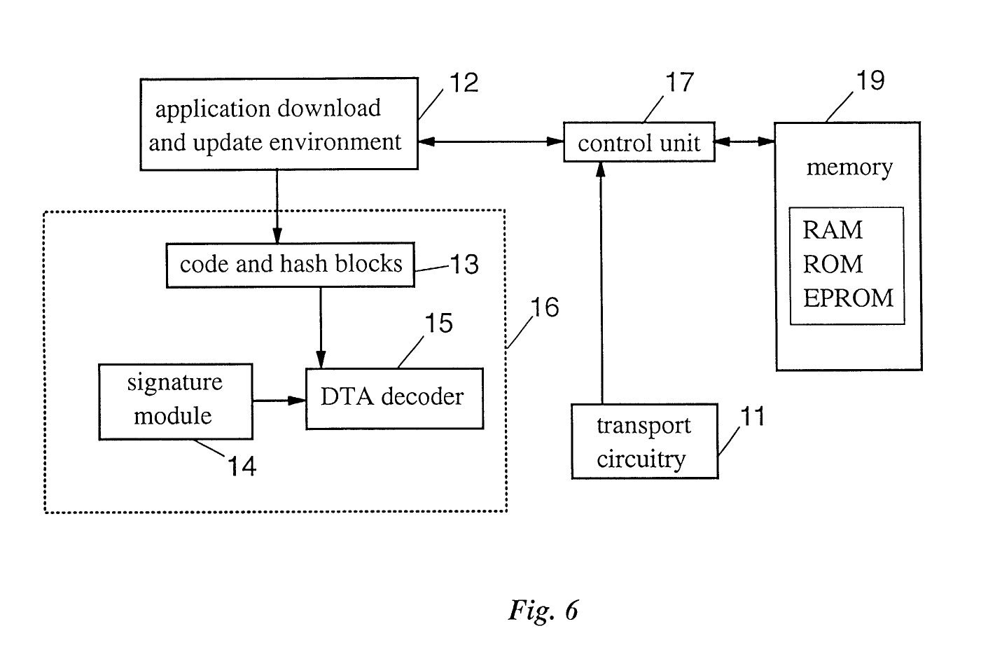

FIG. 6 a functional example for a smartcard (SC);

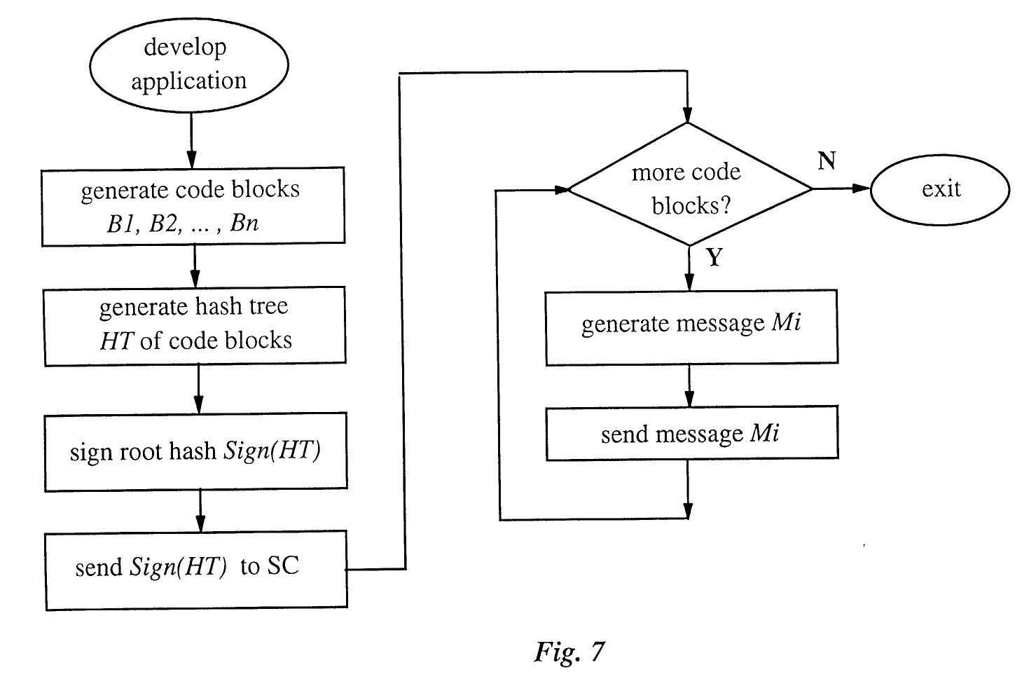

FIG. 7 the control flow for the download of an application at the AP;

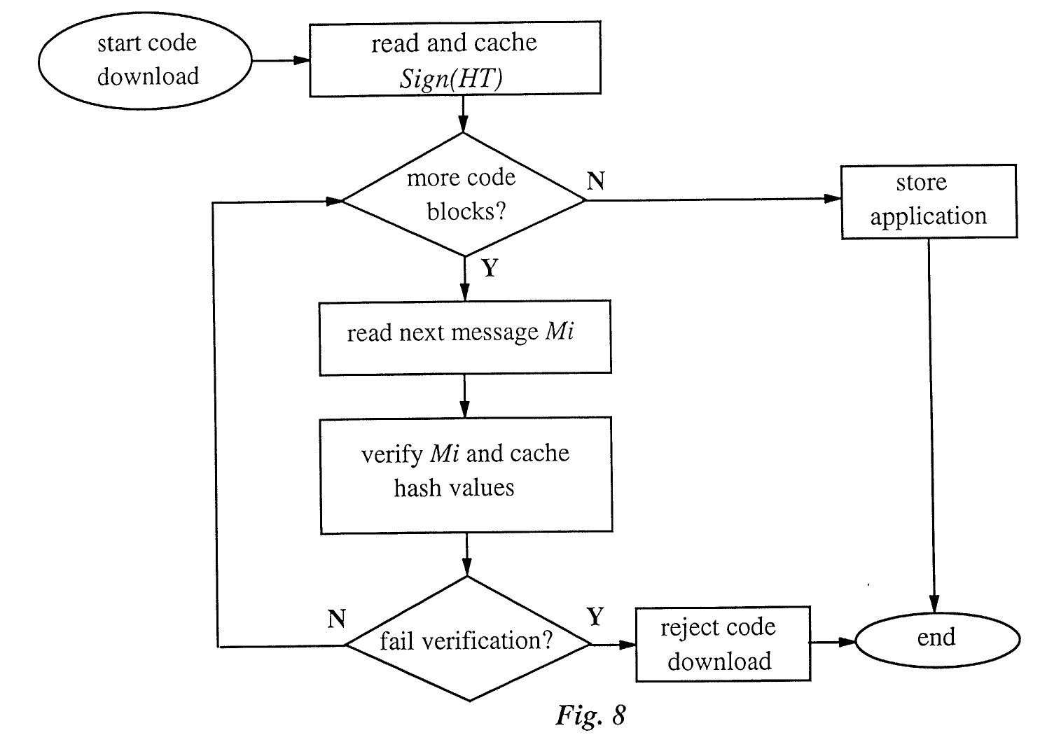

FIG. 8 the control flow for the download of an application at the SC;

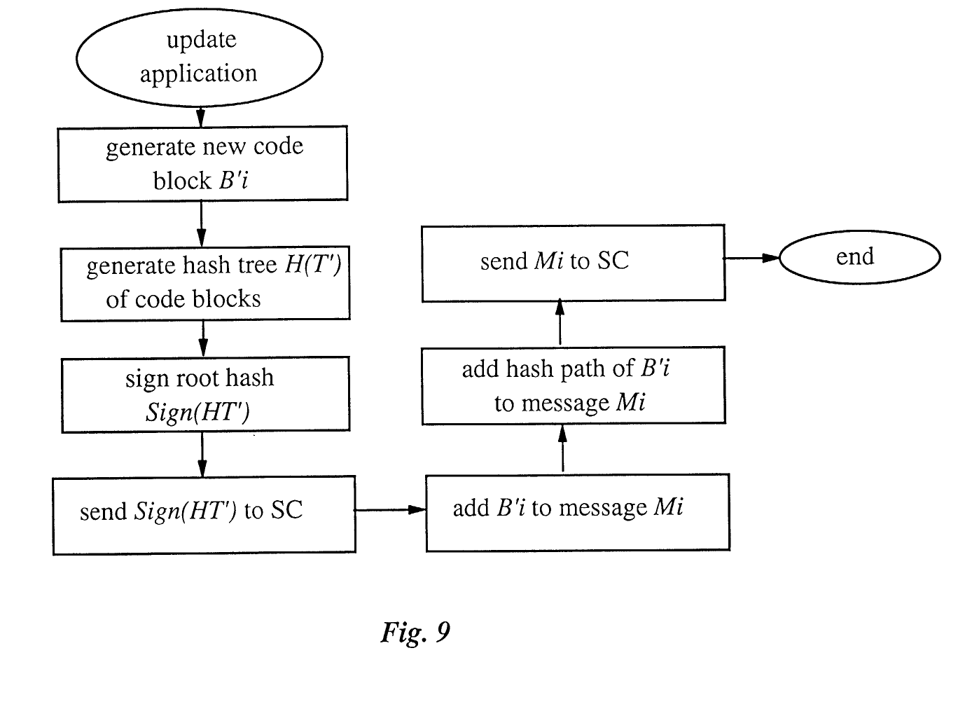

FIG. 9 the control flow for the updating of an application at the AP; and

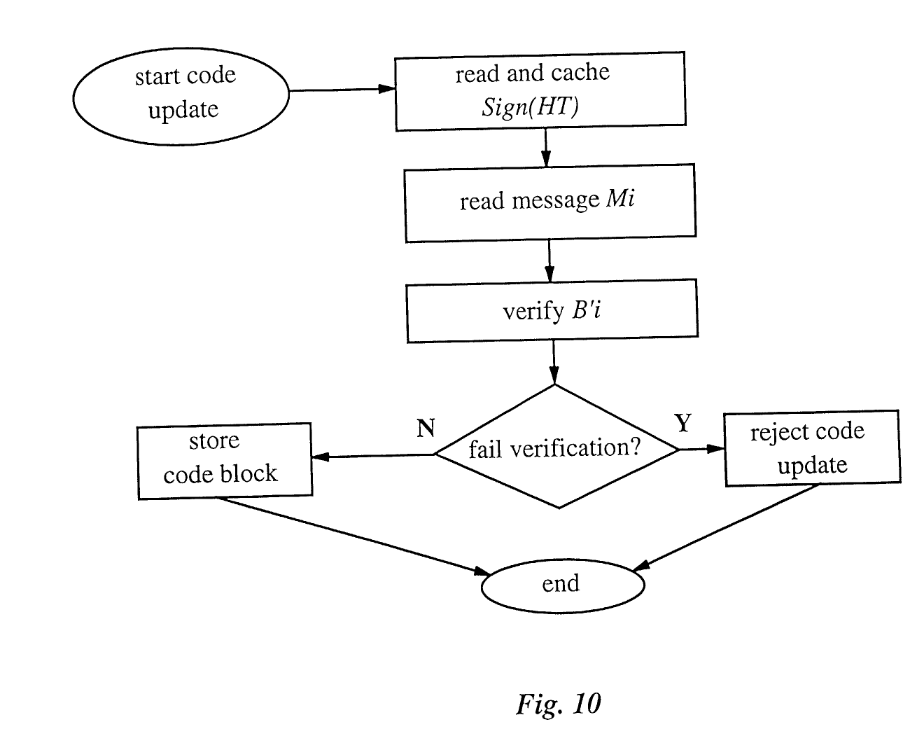

FIG. 10 the control flow for the updating of an application at the SC.

### DOWNLOAD PROTOCOL FROM CASCADE

Several protocols for the secure download and update of SC applications were developed for CASCADE, an ESPRIT project, described under http.//dice.ucl.ac.be/crypto/cascade/cascade.html in the Internet, as mentioned above. They are also documented in J. -F. Dhem: “Design of an Efficient Public Key Library for RISC-based Smart Cards”, PhD Thesis, Catholic University Louvain, 1998.

Be it assumed that the code to be downloaded is partitioned into code blocks B1, B2, . . . , Bn, and that h(*) is a hashing function such as SHA-1. The prior art solution is to link the blocks through the hash function such that the correctness of each block can be verified on-the-fly and further, there is a hash value that is a function of all received blocks. For n blocks, a hash vector H=(H1, H2, . . . H(n+1)) of (n+1) components is produced as shown below.

| | | |
|---|---|---|
| H(n + 1) | ← | random value |
| for i | ← | n downto 1 do |
| | | Hi ← h(H(i + 1)∥Bi) |
| od | | |

wherein

h is a hashing function such as SHA-1

H(n+1) is the hash of a random value

∥ ∥ denotes concatenation

← means assignment of right to left.

Note on H(n+1): the hashing process to produce the Hi is based on the current block Bi and the hash of the previously hashed block B(i+1) as represented by H(i+1). This process is not defined for the block Bn since there is no block B(n+1) that was hashed before it. So we simply start the process by assiging a random value to H(n+1) so that Bn can be hashed to give Hn, and the same hashing process can be used for all blocks.

The above process generates hash values for secure download using a kind of chained hashing. The AP signs H1, and then sends the following (n+2) messages to the SC:

Sign(H1), (H1, B1), (H2, B2), . . . , (Hn, Bn), H(n+1).

The SC first verifies the signature on H1 and then proceeds to verify the hash chain used to form the hash vector. Due to the form of the chain defined above, each application block Bi can be verified after the next 2-tuple (H(i+2), B(i+1)) has been received, which in the terminology defined means a maximum verification delay of one block. If a code block Bi is to be updated, then the hash chain must be recomputed from position i forward due to the linear nature of the hash chain. This scheme will be referred to as “CASCADE with hashes”.

As noted by J. F. Dhem, supra, the n hash values H1, H2, . . . , Hn need not be sent by the AP, since these values can be generated by the SC. This scheme will be called “CASCADE without hashes”. The penalty for this reduced transmission is, however, that the code block verification cannot begin until H(n+1) has been received, meaning that the maximum block delay before verification is O(n) when no hashes are sent. Regardless of whether the hashes are sent at the time of download, they have been discarded by the time of update. Thus, this scheme also has an O(n) update time for a code block.

Using Authentication Trees:

An authentication tree is a data structure used to authenticate information A1, A2, . . . , An. The basic idea is to select a labelled binary tree T with n=2^{d} leaves and to associate Ai with the i-th leaf. The tree will have depth d, where the root is at depth 0 and there are 2ⁱ nodes at level I. The tree T has exactly n leaves associated with the values of A1, A2, . . . , An and exactly n−1 internal nodes with two children each.

It now remains to compute the hash component of the tree. The i-th leaf is labelled with H(Ai)=h(Ai) where Ai is associated with the leaf. Then, beginning at depth d and proceeding to the root at depth 0, each internal node j is labelled with Hj=h(H(L)∥ ∥H(R)), where H(L) and H(R) are the labels of the left and right children, respectively, of node j. The label at the root, denoted H(T), is a hash value that depends on A1, A2, . . . , An.

As shown and explained further down in connection with FIG. 1, the AP can use an authentication tree to authenticate a set of n code blocks B1, B2, . . . , Bn sent to the SC. The AP signs H(T), then sends H(T), its signature and the code blocks B1, B2, . . . , Bn. Note that no block can be rejected as unauthentic until all blocks have been received, since the locally computed value of H(T) is not available until that time. Further, if the generated root hash does not match the received root hash then the incorrect block(s) cannot be identified and all blocks must be retransmitted. Thus, the verification delay for basic tree authentication is O(n). By forming the hashes for the leaves at level d, and then the hash values at level d−1 and so on towards to root, the verification of T will also require a memory of the size O(n). However it is possible to use another recursive method with the property that verification will only require a memory “cost” of (log n+1), which is O(log n).

An advantage of tree authentication over other methods such as linear hashing is that an individual block can be updated in a logarithmic number of messages (or by a single message with a logarithmic number of components). To update Bi to Bi′, the AP first associates the i-th leaf with Bi′ and then recomputes the hash values of the tree to give the new root value H′(T). The AP then signs the new root value H′(T) and then sends H′(T), its signature, and Bi′. The SC then recomputes the hash tree of the code blocks it has after replacing Bi with Bi′, and verifies that the newly computed root hash equals the received value of H′(T). If the hashes agree, and the signature is correct, then Bi is updated as Bi′. Thus, using tree authentication, n code blocks can be downloaded in time O(n) using O(log n) memory, and a block can be updated in O(log n) time and with O(log n) memory.

The Wong-Lam Solution

It is possible to consider B1, B2, . . . , Bn as one transmission group in a digital stream, and then apply the Wong-Lam solution for signing each transmission group that comprises a digital stream. At the sender, the code blocks Bi are arranged into an authentication tree as described above, and the tree is signed by computing its hash. Let Sign(HT) denote the signature on the hash of the authentication tree for the code blocks. To avoid O(n) delay at a receiver, when Bi is to be transmitted, the sender transmits not only Bi, but also its path in the authentication tree and the signature Sign(HT). Referring to FIG. 1, when B1 is to be sent, the sender actually sends (B1, H(B2), H(2), H(6), Sign(HT)). With the hash values H(B2), H(2), H(6) it is clear that the receiver can form the hash path from the leaf for B1 to the root of T and then verify the received code block for B1 against the received signature Sign(HT) value. Similarly when B5 is to be sent, the sender transmits (B5, H(B6), H(4), H(5), Sign(HT)), and the hashes H(B6), H(4), H(5) allow the received code block B5 to be verified. It is clear that the verifications of B1 and B5 are essentially independent in that each code block is sent with sufficient information to perform verification independent of what other information is sent for the transmission group in this the set of code blocks. In particular, the order in which the code blocks are received does not affect their verifiability (the receiver may receive B1 and then B5, or B5 and then B1), and code blocks may also be lost (B5 can still be verified if B1 is lost in transmission).

When verifying a received packet Bi, the whole hash path from the leaf for Bi to the root need not necessarily be recomputed, since the receiver may reuse hash values that were computed during the verification of previously received packets. For example, consider sending (B1, H(B2), H(2), H(6), Sign(HT)) and (B2, H(B1), H(2), H(6), Sign(HT)) for code blocks B1 and B2. Assuming that the code blocks are received in the order B1 and then B2, and further that B1 is verified, then in order to verify B2 the receiver need only recompute the hash of B2 and compare it with the hash value H(B2) associated with B1. The verification of B2 is simplified because its hash path has several hash values in common with the hash path of B1.

In general, the receiver will maintain a cache of hash values that have been verified against the signature in the root hash of the authentication tree. In the example above, if the message (B1, H(B2), H(2), H(6), Sign(HT)) was received, then from FIG. 1 the computation of the hash path for B1 would involve the seven hash values H(B1), H(B2), H(1), H(2), H(5), H(6), and H(T). If H(T) is verified with the signature Sign(HT), then H(B1), H(B2), H(1), H(2), H(5), H(6) and H(T) could also be verified and cached. The hash path for the next block would need only be evaluated until it recomputed one of the cached hash values. A comparison between the computed and cached hash value is made, and if the computed and cached hash value are equal, the block is defined to be verified. In the example above if (B2, H(B1), H(2), H(6), Sign(H(T)) was received after (B1, H(B2), H(2), H(6), Sign(H(T)) and H(B1), H(B2), H(1), H(2), H(5), H(6) and H(T) were cached, then the first computation in the hash path of B2 is H(B2) which could immediately be compared against the cached value of H(B2).

Any hash values generated in the verification of Bi that have not been generated during the verification of any previouly received code blocks are added to the cache. If the cache is arranged as a tree, similar to the original authentication tree at the sender, a code block Bi will be verified by generating its hash path from the leaf representing Bi to the hash of the least ancestor of Bi that has been previously verified (and hence cached). The first code block received arrives when the cache is empty but it can always be verified since all the hash values required to compute its hash path are included in the message for the block, including the signature on the root.

From the discussion above it is clear that the Wong-Lam solution, as applied to signing code blocks, has 0(1) delay for verification. However, the memory requirements at the receiver are O(n), since if all n code blocks are received and verified then O(n) hash values will be cached. No hash values are ever deleted from the cache in the Wong-Lam solution.

But we observe that if Hi is a hash value in the authentication tree, with H(L) and H(R) its left and right children respectively, then Hi need not be cached when H(L) and H(R) are cached since any hash path that involves Hi will be verified by either H(L) or H(R). However, even with this optimization the worst case memory is still O(n) given that packets may be reordered.

The Present Invention, i.e. the DTA Solution:

The method according to the invention, called Dynamic Tree Authentication (DTA), is also based on authentication trees and retains the logarithmic time for block update and also gives a O(1) verification delay. It is generally applicable for code block authenticating as well as for the download/update/increment code block problem, but not restricted to that. This is achieved by sending a particular sequence of hash labels of the internal nodes of the authentication tree along with the code blocks to be authenticated, thus allowing verification of internal nodes of the tree besides the root.

The DTA invention embodiment will be specified by giving the description of two processes, which will be called SendBlocks( ) and ReceiveBlocks( ). Assume that the n code blocks B1, B2, . . . , Bn are to be downloaded from an AP, an application provider, to an SC, a smart card. The SendBlocks( ) process is executed at the AP to create the messages to be sent from the AP to the SC that constitute the downloading process. The SC uses the ReceiveBlocks( ) process to receive the messages from AP and to verify the code blocks based on the information in the messages. Descriptions of the SendBlocks( ) and ReceiveBlocks( ) processes follow.

The SendBlocks( ) process shall be described first in connection with the pseudocode listing A (Listing A) below. As with the other processes to be described as part of the present invention, the SendBlocks( ) process is mainly concerned with accessing the hash values encoded in the authentication tree for the code blocks. For this reason, the steps of the process as described in Listing A are expressed in terms of standard operations on a computer representation of a logical tree. For more details see A. Aho, J. Hopcroft, J. Ullman, “The Design and Analysis of Computer Algorithms”, Addison-Wesley Publishing Company, 1974.

The basic data structure that will be used in SendBlocks( ) is the concept of a “node”. In this desdription, a node has the following attributes: a parent node, a left child node, a right child node, a hash value, and a field that indicates if the hash value for the node has been previously sent with a code block. These fields for a given node node are accessed as follows:

parent(node) gives the parent of node,

node.left gives the left child of node,

node.right gives the right child of node,

node.hash is the hash value of node, and finally

node.hashsent is true if the hash value for node has been previously sent and is false otherwise.

We also assume that leaf nodes have no children, and the root of the tree has no parent. The root value is a node distinguished by the name root, and root.hash denotes the hash of the authentication tree. Since by construction the leaf nodes of the authentication tree correspond to code blocks, we also let node (Bi) denote the leaf node corresponding to Bi.

With this notation, we now describe the SendBlocks( ) process as shown in Listing A. This routine will be run by the AP that wishes to send the code blocks B1, B2, . . . , Bn to the SC. Each code block Bi will be sent in a message Mi, where Mi will contain Bi and possibly some additional hash values from the authentication tree for B1, B2, . . . , Bn to facilitate verification at the SC with low delay and memory overhead.

Listing A

| | |
|---|---|
| 1. | SendBlocks( B1, B2, . . . , Bn) |
| | /* generate and sign authentication tree, send signature */ |
| 2. | T ← authentication tree for B1, B2, . . . , Bn; |
| 3. | Sign (H(T)) ← AP signature on HT; |
| 4. | send(Sign(HT)); |
| | /* generate message blocks */ |
| 5. | for i from 1 to n do |
| 6. | Bi ← Bi; |
| 7. | ptr ← node(Bi); |
| 8. | while (ptr <> root) and (ptr.parent.right.hashsent = false) do |
| 9. | Mi ← (Mi ∥ ptr.parent.right.hash); |
| 10. | ptr.parent.right.hashsent = true; |
| 11. | ptr ← parent(ptr); |
| 12. | od ; /* while */ |
| 13. | send(Mi) |
| 14. | od; /*for*/ |
| 15. | end; /* SendBlocks */ |

When the SendBlocks( ) process is executed, all n code blocks are passed as inputs. The authentication tree for B1, B2, . . . , Bn is constructed and hashed (steps 2 to 3), with the resulting signature Sign(HT) sent to the SC (step 4). The messages corresponding to the code blocks that will be used to verify this signature are now created.

SendBlocks( ) has a main for loop (steps 5 to 14) that executes n times and processes the i-th block Bi at the i-th iteration. The outcome of the i-th iteration of the main loop of SendBlocks( ) is the construction of the i-th message Mi that is sent to the receiver at step 13. Mi is initialized to Bi and then further processing (from steps 7 to 12) adds any additional hash values to Mi that will be required at the SC to perform the verification of Bi after it is received.

We now explain how the additional hashes for Bi are determined by the SendBlocks( ) process from steps 7 to 12. At step 7, a temporary value ptr is assigned to node(Bi), the leaf node corresponding to Bi. The while loop from steps 8 to 12 traces the path from node(Bi) to the root node of the authentication tree by repeatedly assigning ptr to its parent (step 11). At each new node referenced by ptr, if the hash value of the right brother node has not been sent as part of a previous message then this hash value is appended to Mi. Equivalently if ptr.parent.right.hashsent is false, then ptr.parent.right.hash is appended to Mi at step 9, and ptr.parent.right.hashsent is set to true to indicate that this hash value need not be sent with any future message. This process of appending hash values to Mi continues in the while loop until either the root is reached or ptr references a node for which the hash of its right brother was sent by a previous message. At this point, the message Mi for code block Bi is complete and can be sent to the SC. The creation of the next message M(i+1) for the code block B(i+1) begins at the (i+1)-st iteration of the main loop of SendBlocks( ). The main loop continues in this manner until all n messages for all n code blocks have been generated and sent, at which point SendBlocks( ) exits.

As an example, consider executing SendBlocks( ) on the authentication tree of FIG. 1 with the call SendBlocks(B1, B2, . . . , B8). After the signature on HT has been sent, the contents of the eight messages M1, M2, . . . , M8 corresponding to the code blocks B1, B2, . . . , B8 are

M1={B1, H(B2), H2, H6},

M2={B2},

M3={B3, H(B4)},

M4={B4},

M5={B5, H(B6), H4},

M6={B6},

M7={B7, H(B8)},

M8={B8}.

We make several observations about the message blocks. First, the message blocks for even indexed code blocks—in this case M2, M4, M6, M8—consist simply of the corresponding code block. This is because H(B(2i)) is required to verify H(B(2i−1)). Second, the longest message is M1, since at the time M1 is constructed no hash values have been sent, and M1 then includes the full hash path for B1. In general, no message block Mi produced by SendBlocks( ) will require more than d additional hashes to be sent with the code block Bi when n=2^{d}. Third, we see that each of the hash values sent with a message are the hash values of right children of nodes in the authentication tree. Since there are n−1 internal nodes in an authentication tree with n leaves, SendBlocks( ) will generate less than n/2 hash values to be sent with the n messages M1, M2, . . . , Mn associated with B1, B2, . . . , Bn. So much on the SendBlocks( )process.

Now follows the description of the ReceiveBlocks( ) process. Using this process, the SC processes the signature and messages it receives from the AP; the process is shown in Listing B further down.

The ReceiveBlocks( ) process maintains the global data structure cache, which is an array of hash values. The fields of cache can be addressed from 0 up to d, the depth of T. For each level i of the authentication tree T. field cache[i] holds hash value A(j) of a node that has been verified last in the processing of a previous message.

In the setup phase (steps 2-5 of Listing B), the ReceiveBlocks( ) process first reads and verifies the signature Sign (HT) on the authentication tree T, extracts the hash value HT of the root, and then stores the hash HT of the authentication tree in field cache[0].

ReceiveBlocks( ) has a main for loop (steps 6-20) that executes n times and receives and verifies the i-th code block at the i-th iteration. At the i-th iteration, it receives message Mi (step 7), extracts code block Bi out of message Mi (step 8), computes the hash value H(Bi) of that code block and stores the computed hash value in the temporary variable h (step 9). Next, ReceiveBlocks( ) computes the hash values of intermediate nodes in the authentication tree until it reaches a node which has already been verified in the processing of a previous message (steps 10-15). For each not yet verified node, ReceiveBlocks( ) extracts the hash value of its right brother from the received message Mi and stores the value in the corresponding field of the cache (step 12), computes the hash value of the parent node and stores it in temporary variable h (step 13). Finally, the routine compares the computed hash value stored in variable h with the hash value of the already verified intermediate node (step 16). If the values are equal, block Bi is considered verified and ReceiveBlocks( ) clears the hash value of the already verified intermediate node in the cache (step 17). Otherwise, ReceiveBlocks( ) indicates an error (step 18). The main loop continues in this manner until all n messages for all n blocks have been received and verified, at which point ReceiveBlocks( ) exists.

Listing B

| | |
|---|---|
| 1. | ReceiveBlocks(n) |
| | /* n = 2^{d} */ |
| 2. | depth = d; |
| 3. | cache[0 . . . depth]; /* global array of hash values */ |
| | /* read authentication tree signature */ |
| 4. | sig ← read (Sign(HT)); |
| 5. | cache[0] ← HT; |
| | /* read messages and verify code blocks */ |
| 6. | for i from 1 to n do |
| 7. | Mi ← read(); |
| 8. | Bi ← code block from Mi; |
| 9. | h ← H(Bi); |
| 10. | j ← depth; |
| 11. | while(j > 0) and (cache[j] = 0)do |
| 12. | cache[f] ← head(Mi); |
| 13. | h ← H(h ∥ cache[j]); |
| 14. | j ← j−1; |
| 15. | od; /*while*/ |
| 16. | if cache[j] = h |
| 17. | then cache[j] ← 0; |
| 18. | else error |
| 19. | fi |
| 20. | od; /* for */ |
| 21. | end; /* ReceiveBlocks */ |

As an example, consider executing ReceiveBlocks( ) on the authentication tree of FIG. 1. After the signature on HT has been verified, field cache[1] holds HT. All other fields are empty. Next, ReceiveBlocks( ) receives the first message:

M1={B1, H(B2), H2, H6}

As the fields cache[4], cache[3], and cache[2] are empty, the while loop (steps 11-15) will extract the three hash values H(B2), H2, and H6 from the message. These hash values form the full hash path for B1 and allow to compute and verify node HT. As a side effect, nodes H(B2), H2, and H6 are also verified and thus stored in the cache. As node HT is verified, field cache[1] is cleared.

Let us assume that the next message received contains an even indexed code block. Then the previous message contained the code block's hash value and got stored in field cache[4]. Thus, the even indexed code block can be immediately verified and field cache[4] will be cleared. In general, whenever a node is verified, the corresponding field in the cache is cleared (step 17).

Finally, let us consider the case when the next message received contains an odd indexed code block B(2j+1). We know from above that the previous iteration (iteration 2j) of the for loop cleared field cache[4] and thus at least the hash value of the next code block B(2j+2) will be extracted from the message. If the parent node has not been verified previously, the hash value of the parent's right child will be extracted from the message. Note that intermediate nodes get verified before their right child got verified. Thus, walking up towards the root until an already verified node is reached, the least hash path to verify the code block is obtained.

An example for an authentication tree with n=8 is shown in FIG. 1. The storage requirements for a straightforward process for transmitting data and/or applications from an AP to an SC according to the invention are shown in FIG. 2, whereas the DTA scheme according to a further improvement of the invention is shown in FIG. 3.

FIG. 1 shows the hash tree that results from authenticating the 8 blocks B1, B2, . . . , B8. The blocks are first grouped in pairs, then hashed to give H1, H2, H3, H4, then paired again and hashed to give H5, H6. One more hash is used to compute the root hash H(T). It should be observed that the hash of the blocks is computed “bottom up”, meaning that hashing begins at the leaves, here the blocks B1, B2, . . . , B8, and further hash values are computed as one proceeds towards the root. In another way, one sees that the tree has a total depth of 3, where H5 and H6 are at depth 1, and H1, . . . , H4 are at depth 2, and the B1 are at depth 3. By convention the root is usually assumed to be at depth 0. The hashing process begins at depth 3, goes to depth 2, then depth 1, finally producing the root value at depth 0.

In a simple process, the AP signs H(T) and sends B1, B2, . . . , B8, Sign(H(T)) to the SC for verification. It is assumed that the SC receives the blocks in the order B1, then B2, and so on until B8, and then the signature Sign(H(T)). To verify the signature on the blocks, the SC must repeat all the hashing computations shown in FIG. 1, so that the correct value of H(T) is found.

FIG. 2 shows the computation and storage required by the SC as each block Bi is received. For example, when the first block B1 is received, it is hashed and this hash value H(B1) is stored. When B2 arrives, it is also hashed to result in H(B2), which is then hashed with H(B1) to give H1. This value H1 must be stored for the later computation of H5. The various colums of the table in FIG. 2 show which hash values must be computed and stored for later use.

It is obvious from the above description that the described straightforward process results in the authentic and reliable transmission and/or update of data between a AP and a SC, but that it also has two disadvantages. These are the late availability of any final authentication results and the necessity to calculate the complete hash tree whenever an error is detected.

Now, for the improvement of the invention, namely the application of the DTA scheme, FIG. 3 shows an example of the messages sent from the AP to the SC for n=8 code blocks. Thus, the authentication tree of FIG. 1 still applies. The first few rows of in FIG. 3 shall be explained in detail. Initially, the AP sends the signature Sign(HT). SC validates the signature and stores value HT. Next, AP sends message {B1H(B2),H2,H6}. With this information, root value HT′ can be calculated (H1=h(h(B1)∥ ∥H(B2), H5=h(H1∥ ∥H2), and HT′=h(H5∥ ∥H6)) by the SC. If the calculated value HT′ is equal to the value HT contained in the signature, code block B1 is verified. As a side effect, also values H(B2), H2, and H6 are verified and therefore stored in the SC hash storage. The AP next sends message {B2}. Now, the SC can immediately verify block B2, since it can compute its hash value H(B2) and compare it with the stored value of H(B2) as received in the previous message Value H(B2) is removed from the hash storage. Message {B3,H(B4)} follows next. SC computes the hash value H(B3) of the code block and the hash value of the parent node H2=h(H(B3)∥ ∥H(B4)). As the parent node H2 is already in the hash storage, SC can compare both values to verify code block B3. If equal, SC removes H2 from the cache but includes the newly received hash value H(B4).

The table shows which leaves and internal nodes are verified as each new message is received at the SC. Note that the storage needed for the intermediate hash values has the size O(log n).

The table in FIG. 4 compares the DTA solution according to the present invention with the CASCADE and TA (tree authentication) approach and clearly shows the advantage of DTA over the prior art.

Incremental Code Blocks:

It may also be the case that a given application of n blocks B1, B2, . . . , Bn is to be increased to have n+1 blocks with the addition of a new code block B(i+1). Adding a new code block can be considered as a special update operation in DTA. Let H(T) be the DTA authentication tree for the code blocks B1, B2, . . . , Bn, which will consist of a binary tree with internal nodes and leaves, where each internal node will have two children (excluding the case of n=1). Each leaf is a code block Bi, and is positioned at some depth d in H(T). To add a new code block B(n+1) to H(T), one considers the set of leaves that are at the mimimum depth d in H(T), and pick one at random, here denoted as Bi. Then the node for Bi is replaced by an internal node that has Bi and B(n+1) as its children.

To add the new code B(i+1) block to those existing in the SC, the AP adds B(n+1) to the H(T) as described above and then computes the new root value H′(T). Then, the AP sends H′(T), its signature Sign (HT′), the index i and B(n+1) to the SC, where i indicates the leaf in the current authentication tree that will become the parent of the new code block. The SC inserts B(n+1) into the authentication tree, recomputes the hash tree and verifies that the newly computed root hash equals the received value of H′(T). If the hashes agree, and the signature is correct, then B(n+1) is added to the code blocks. The above protocol naturally extends to the case where m new blocks are added.

FIG. 5 shows the main elements of an embodiment of the Application Provider (AP). The AP has a environment 1 for developing and updating applications. Environment 1 consists of various software tools that may include a compiler, i.e. a tool for translating an application written in a high level computer language into a form suitable for execution on a another computing device, such as a smartcard, a profiler for improving code performance, and a debugger for assisting in the removal of logical errors from the application. Environment 1 will also have access to various existing application libraries to perform standard functions such as reading and writing to a file, making a network connection, or opening a window on a display. The application development and update environment 1 will be embodied as software on a general computing device that has a control unit 7, transport circuitry 11, which is usually a network connection, a user input device 8, for example a keyboard, memory 9, and a display device 10.

The AP uses the application development and update environment 1 to create an application. When the development is complete, the result will be application code 2 suitable for execution on a class of computing devices.

Once the application development is completed using the development environment 1, which has produced application code 2, the AP can now transmit the application code 2 to various devices that will execute the application code.

The application code is now passed to part 6 of the AP which is responsible for formatting the application code 2 for transmission to the receiving device. Part 6 of the AP responsible for formatting the application code 2 for transmission to the receiving device consists of a hash tree encoder 3, a signature module 4 and the DTA encoder 5. The application code 2 is passed to the DTA encoder 5, which is an implementation of the SendBlocks( ) process of Listing A. DTA encoder 5 first uses the hash tree encoder 3 to produce a hash tree for the application code, and then passes the hash tree to the signature module 4 for signature. The signature is then passed to the transport circuitry 11 for transmission to the smartcard, SC. If the application code consists of n code blocks B1, B2, . . . , Bn, then DTA encoder 5 produces n messages M1, M2, . . . , Mn. As each message Mi is generated, it is passed to the transport circuitry 11 for transmission to the SC.

FIG. 6 shows the main elements of an embodiment of a smartcard (SC) that will receive the code blocks from the AP. The SC has a environment 12 for receiving new applications and updating existing applications. Before the SC will accept new or updated (application) code blocks 13 via transport circuitry 11 to be written to long term memory 19 (ROM, EPROM and/or RAM), the AP which produced the code blocks must be verified. This verification takes place in part 16 which consists of a signature module 14 and a DTA decoder 15. The messages 13 produced by the AP for the code blocks are passed to DTA decoder 15 which implements the ReceiveBlocks( ) process of Listing B. DTA decoder 15 uses signature module 14 to verify the first code block received. The other received code blocks 13 are verified using cached and received hash values as described in the RecieveBlocks( ) process of Listing B. If all code blocks are verified, the code blocks are written to long term memory 19.

In FIG. 7, the control flow at the AP of FIG. 5 is shown. The application is first developed in the application developed environment 1 (FIG. 5) and then formatted into code blocks B1, B2, . . . , Bn. These code blocks are then encoded into a hash tree using the hash tree encoder 3. The root of the hash tree is signed to give Sign(HT) using the signature module 4 and then sent to the smartcard, SC. Each code block Bi is then processed according to the SendBlocks( ) process of Listing A to produce message Mi, which is sent to the SC. When all n code blocks have been processed then the control flow exits.

In FIG. 8, the control flow at the SC of FIG. 6 is shown. The SC receives the signature Sign(HT) on the code blocks B1, B2, . . . , Bn and caches the signature for the verification of the code blocks to follow. While there are more code blocks to receive, the SC reads the next message Mi as described in the ReceiveBlocks( ) process of Listing B and verifies code block Bi. The verification of Bi will be based on cached hash values and hash values included in Mi. Additional hash values generated by the verification process may be cached, according to the ReceiveBlocks( ) process of Listing B. If any of the code blocks fail verification, then the application download fails; otherwise the verified application is stored on the smartcard, SC.

FIGS. 9 and 10 describe the control flow at the application provider, AP, and the smartcard, SC, for the update of a single code block. In FIG. 9, the application provider AP modifies code block B′i in an application that consists of the n code blocks B1, B2, . . . , Bn, where these code blocks have been previously downloaded to and verified by the SC. The AP first recomputes the hash tree for the code where the orginal code block Bi is replaced by B′i. The root hash HT′ for B1, B2, . . . , B′i, . . . , Bn will be different (with high probability) from the root hash HT for B1, B2, . . . , Bi, . . . , Bn. The AP signs the new root hash to give Sign(HT′), which is sent to the SC. Next the AP formats a message Mi which will be sent to the SC to verify that B′i is in fact a new code block for the application currently represented by the code blocks B1, B2, . . . , Bn. The message Mi is initially the updated code block B′i, and the AP then adds the hash path of B′i from the hash tree for B1, B2, . . . , B′i, . . . , Bn to the message Mi. The AP then sends Mi to the SC and exits.

In FIG. 10, the first step of application update at the SC is to receive the new signature Sign(HT′) on the updated application. The SC stores the signature and then waits to receive the update message Mi containing the new code block B′i and hash information to verify Sign(HT′). The SC computes the hash path of B′i based on the hashes received and other computed hashes, which produces a root hash value that is to be compared against the root hash used to compute Sign(HT′). If the signature verifies, then the code block is accepted and the application is updated; otherwise the new code block is rejected. It is clear that since the depth of the hash tree is O(log n) then the SC will require O(log n) storage to perform the update.

FIGS. 9 and 10 only address the case where a single code block is updated, but clearly the AP may wish to update multiple code blocks. If there are multiple code blocks to be updated, then each code block may be updated separately using the flows of FIGS. 9 and 10. This would require a signature verification for each updated code block, which would be costly. However, it is possible to modify the SendBlocks( ) and ReceiveBlocks( ) processes to make multiple code block more efficient that multiple single code block update. It is clear to a person skilled in the art how to modify the SendBlocks( ) and the ReceiveBlocks( ) processes to support efficient update in such a case.

The presented new and inventive DTA method for dowloading to and/or updating and authenticating data or applications on a portable device has clear advantages, for the chosen specific example of a smartcard as portable device as well as for other applications. To a person skilled in the art, the invention can easily be adapted and applied to any problem where complex applications must be downloaded to or updated in a device having constraints in memory, processing speed and/or bandwidth or where updating time and/or security play significant roles.

1. A method for downloading, updating and/or incrementing applications and/or data from a provider (AP) via a transmission channel of limited bandwidth onto a device (SC), in particular a portable device with limited processing power and/or memory,
characterized by
at the provider (AP), generating code blocks Bi of the application or data to be transmitted,
defining an authentication function comprising a one-way function,
computing an authentication value H(Bi) for each block Bi to be transmitted,
selecting an authentication tree for said authentication values H(Bi),
computing authentication values Hi of the branches and the root authentication value HT of said tree,
signing said root authentication value HT, thereby generating Sign(HT),
generating messages Mi comprising said blocks Bi and, partly, selected ones of said authentication values H(Bi),
transmitting said signed root authentication value Sign(HT) and said messages Mi from said provider (AP) to said device (SC),
in said device (SC), upon receiving any one of said messages Mi, extracting said block Bi, computing the corresponding authentication value H(Bi) and cashing it, computing selected intermediate authentication values Hi along said tree until a previously verified authentication value <<has this value a name??>> is reached,
comparing said computed intermediate authentication value Hi with said previously verified authentication value and,
if the values are equal, accepting said received block Bi or, if otherwise, indicating an error.

2. The method according to claim 1, wherein
the generated code blocks Bi of the application or data to be transmitted are sequentially transmitted,
the computing and comparing in the device (SC) is sequentially executed until all blocks Bi are verified, and
the application or data is considered correctly received, when no error was indicated.

3. The method according to claim 1 or 2, wherein
the one-way function of the authentication function is a hashing function,
the authentication tree is a hash tree HT, in particular a binary and/or symmetrical tree, of the code blocks Bi generated in the provider (AP).

4. The method according to any of the preceding claims, wherein
a SendBlocks process is defined in the provider (AP), consisting of a several loops which iteratively construct an i-th message Mi consisting either of a block Bi alone or of a block Bi plus one or more authentication values Hi and/or H(Bi).

5. The method according to claim 4, wherein
each 2j-th message Mi consists of the corresponding block Bi alone, whereas each (2j+1)-th message Mi includes the full or part of the authentication or hash path from the corresponding block Bi towards the root of the authentication tree.

6. The method according to any of the preceding claims, wherein
a ReceiveBlocks process is defined in the device (SC), consisting of several loops,
said process iteratively evaluating an i-th message Mi by extracting from a received messages Mi the corresponding block Bi and,
if the received message Mi includes one or more authentication values Hi and/or H(Bi), extracting these values and caching them for later verification.

7. The method according to claim 6, wherein
storing in the device (SC) only those authentication values H(Bi) and/or Hi and/or HT needed to authenticate subsequently transmitted blocks Bi and
clearing all authentication values H(Bi) and/or Hi not needed in the further process.

8. A method for transmitting applications and/or data from a sender to a receiver, characterized by
in said sender, partitioning said applications and/or data into blocks,
defining an authentication function comprising a one-way function,
computing an authentication value for each of said blocks,
selecting an authentication tree for said authentication values of said blocks and computing authentication values of the branches and a root authentication value of said tree,
sequentially sending said blocks with selected ones of said block and/or branch authentication values and/or said root authentication value to said receiver,
extracting in said receiver said application or data block,
computing in said receiver those authentication values that are available along the branch towards the root,
storing in said receiver authentication values needed to authenticate subsequently transmitted data blocks, and
verifying in said receiver each subsequently received block with computed and/or stored authentication values.

9. Provider apparatus (AP) for downloading, updating and/or incrementing applications and/or data partioned into blocks onto a device (SC), in particular a portable device with limited processing power and/or memory, in which apparatus
an authentication function comprising a one-way function is defined and
an authentication tree is selected for authenticating said blocks, said apparatus including
means (3) for computing an authentication value for each of said blocks and of the branches of said tree,
means (4) for computing a root authentication value,
means (5) for building messages from said blocks and selected ones of said authentication values, and
transport means (11) for sequentially sending said messages to said receiver.

10. Device (SC), in particular a portable device with limited processing power and/or memory, for evaluating messages received from a provider (AP) for downloading, updating and/or incrementing applications and/or data partioned into blocks on said device, in which the provider has
defined an authentication function comprising a one-way function and
selected an authentication tree is for authenticating said blocks, said device including
transport means (11) connected to said provider (AP) for receiving messages from said provider,
means (15) for extracting said application or data block and for computing and storing authentication values are available along the branches towards the root of said authentication tree,
means (14) for verifying signatures extracted from said blocks and for verifying each subsequently received block with computed and/or stored authentication values, and
storage means (19) for authentication values needed to authenticate subsequently transmitted blocks.
